(19) United States
(12) Patent Application Publication
(10) Pub. No.: US 2025/0391178 A1
(43) Pub. Date: Dec. 25, 2025

(54) OBJECT RECOGNITION APPARATUS, OBJECT RECOGNITION METHOD, AND OBJECT RECOGNITION PROGRAM

(71) Applicant: TOYOTA JIDOSHA KABUSHIKI KAISHA, Toyota-shi (JP)

(72) Inventor: Takahiro Kawano, Chofu-shi (JP)

(73) Assignee: TOYOTA JIDOSHA KABUSHIKI KAISHA, Toyota-shi (JP)

(21) Appl. No.: 19/211,826

(22) Filed: May 19, 2025

(30) Foreign Application Priority Data
Jun. 20, 2024 (JP) 2024-099893

(51) Int. Cl. G06V 20/58; G06V 10/26

(52) U.S. Cl. CPC G06V 20/58; G06V 10/26

(57) ABSTRACT

An object recognition apparatus includes an object recognition unit configured to recognize an object around a vehicle, which is present within a detection range of an external sensor for detecting the object, based on a detection result of the external sensor; and an inference unit configured to infer that the object is in a hidden state below the vehicle when the object is recognized to deviate from the detection range of the external sensor toward underneath of the vehicle.

### CROSS-REFERENCE TO RELATED APPLICATIONS

This application claims the benefit of priority from Japanese Patent Application No. 2024-099893, filed on Jun. 20, 2024, the entire contents of which are incorporated herein by reference.

### TECHNICAL FIELD

The present disclosure relates to an object recognition apparatus, an object recognition method, and an object recognition program.

### BACKGROUND

For example, Japanese Unexamined Patent Publication No. 2022-122196 discloses an object detection apparatus that detects the intrusion of an object between a transmission/reception unit and a road surface as an abnormality using ultrasonic waves traveling vertically downward from the transmitter/receiver.

The apparatus described above uses a transmission/reception unit that emits ultrasonic waves traveling vertically downward. However, vehicles equipped with sensors that detect what is directly below the vehicles are less common than vehicles equipped with external sensors that detect objects around the vehicles.

### SUMMARY

An example of an object recognition apparatus includes: an object recognition unit configured to recognize an object around a vehicle, which is present within a detection range of an external sensor for detecting the object, based on a detection result of the external sensor; and an inference unit configured to infer that the object is in a hidden state below the vehicle when the object is recognized to deviate from the detection range of the external sensor toward the underneath of the vehicle.

According to the example of the object recognition apparatus, when the object recognized within the detection range of the external sensor deviates from the detection range of the external sensor toward the underneath of the vehicle, it is inferred that the object is in the hidden state below the vehicle. Therefore, it is possible to infer that there is a risk that an object may be hidden below the vehicle by using an external sensor that detects objects around the vehicle.

In some examples, when the object inferred to be in the hidden state is detected again within the detection range of the external sensor, the inference unit may infer that the object is no longer in the hidden state.

In some examples, when a state in which the object inferred to be in the hidden state is detected again within the detection range of the external sensor does not continue for a predetermined no-hiding determination time, the inference unit may not infer that the object is no longer in the hidden state.

An example of an object recognition method is an object recognition method of an object recognition apparatus for recognizing an object around a vehicle, and includes: recognizing the object present within a detection range of an external sensor for detecting the object, based on a detection result of the external sensor, by the object recognition apparatus; and inferring that the object is in a hidden state below the vehicle by the object recognition apparatus when the object is recognized to deviate from the detection range of the external sensor toward the underneath of the vehicle.

According to the example of the object recognition method, when the object recognized within the detection range of the external sensor deviates from the detection range of the external sensor toward the underneath of the vehicle, it is inferred that the object is in the hidden state below the vehicle. Therefore, it is possible to infer that there is a risk that an object may be hidden below the vehicle by using an external sensor that detects objects around the vehicle.

An example of an object recognition program is an object recognition program causing a computer to function as an object recognition apparatus for recognizing an object around a vehicle based on a detection result of an external sensor for detecting the object. The object recognition program causes the computer to function as: an object recognition unit configured to recognize the object present within a detection range of the external sensor based on the detection result of the external sensor; and an inference unit configured to infer that the object is in a hidden state below the vehicle when the object is recognized to deviate from the detection range of the external sensor toward the underneath of the vehicle.

According to the example of the object recognition program, when the object recognized within the detection range of the external sensor deviates from the detection range of the external sensor toward the underneath of the vehicle, it is inferred that the object is in the hidden state below the vehicle. Therefore, it is possible to infer that there is a risk that an object may be hidden below the vehicle by using an external sensor that detects objects around the vehicle.

According to some examples, it is possible to infer that there is a risk that an object may be hidden below the vehicle by using an external sensor that detects objects around the vehicle.

### BRIEF DESCRIPTION OF THE DRAWINGS

FIG. 1 is a block diagram illustrating an example of an object recognition apparatus.

FIG. 2 is a drawing for explaining an example of inferring that an object is in the hidden state.

FIG. 3 is a drawing for explaining another example of inferring that an object is in the hidden state.

FIG. 4 is a drawing for explaining an example of invalidating an inference that an object is in the hidden state.

FIG. 5 is a drawing for explaining an example of continuing to infer that an object is in the hidden state.

FIG. 6 is a drawing for explaining another example of continuing to infer that an object is in the hidden state.

FIG. 7 is a flowchart illustrating an example of a process for inferring that an object is in the hidden state.

FIG. 8 is a flowchart illustrating an example of a process for inferring that an object is no longer in the hidden state.

### DETAILED DESCRIPTION

Hereinafter, an example of the present disclosure will be described with reference to the drawings.

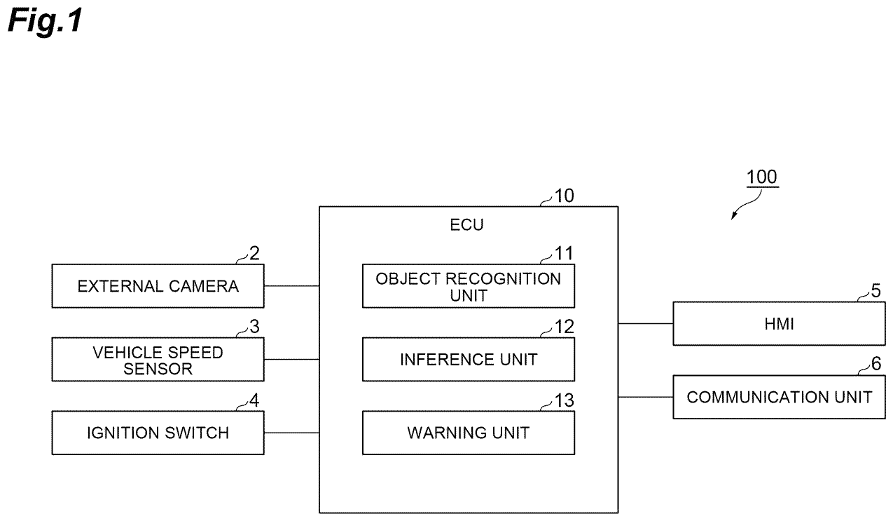

FIG. 1 is a block diagram illustrating an example of an object recognition apparatus. An object recognition apparatus 100 shown in FIG. 1 is an apparatus that infers that there is a risk that an object may be in a hidden state below a vehicle, such as a passenger car or a freight vehicle, using an external camera 2 (external sensor) mounted on the vehicle. The object recognition apparatus 100 includes an electronic control unit (ECU) 10, the external camera 2, a vehicle speed sensor 3, an ignition switch (IG switch) 4, a human machine interface (HMI) 5, and a communication unit 6. The object recognition apparatus 100 can also be applied to a vehicle capable of performing driving assistance control or a vehicle capable of performing autonomous driving control.

### [Configuration of Object Recognition Apparatus]

As shown in FIG. 1, the object recognition apparatus 100 includes the ECU 10 that performs overall control of the apparatus. The ECU 10 is an electronic control unit having a central processing unit (CPU) and storage units such as a read only memory (ROM), a random access memory (RAM), and an electrically erasable programmable read-only memory (EEPROM). In the ECU 10, for example, the CPU executes programs stored in the storage unit to realize various functions. The ECU 10 may include a plurality of electronic units. The ECU 10 may be configured as an integrated unit with the external camera 2, or may be configured as a unit separated from the external camera 2.

The ECU 10 is connected to the external camera 2, the vehicle speed sensor 3, the ignition switch 4, the HMI 5, and the communication unit 6. The external camera 2 is a camera for imaging the surroundings of a vehicle 1. The external camera 2 includes a front camera for imaging the front of the vehicle 1. The front camera may be installed on the inner side of the windshield of the vehicle 1. The external camera 2 may include a rear camera for imaging the rear of the vehicle 1, or may include side cameras (a left side camera and a right side camera) for imaging the sides of the vehicle 1. The external camera 2 may be a panoramic view camera installed on the grille, door mirror, or bumper of the vehicle 1. The external camera 2 has a distance measurement function. The external camera 2 may be a camera having a distance measurement function, such as a stereo camera. The external camera 2 may be a monocular camera capable of measuring the distance to an object in a captured image by performing predetermined image processing on the captured image. The external camera 2 transmits the captured image information to the ECU 10.

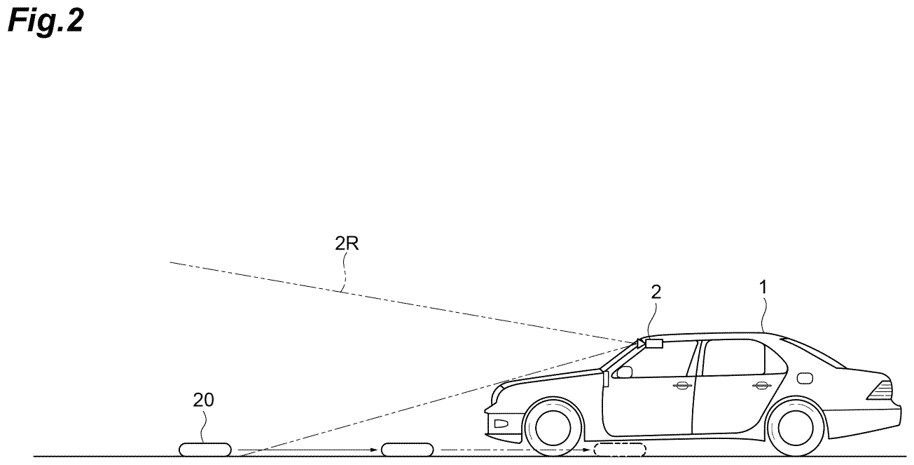

The external camera 2 has a detection range 2R. The detection range 2R is a range in which the external camera 2 can capture an image of an object. For example, FIG. 2 shows the vehicle 1, the external camera 2, the detection range 2R (two-dot chain line) of the external camera 2, and an object 20. In the example shown in FIG. 2, the detection range 2R of the external camera 2 serving as a front camera is a space having a fan-shaped cross section interposed between a pair of two-dot chain lines extending above and below the external camera 2 within a predetermined range in side view of the vehicle 1. In such a detection range 2R, a blind spot is located below the lower two-dot chain line in side view of the vehicle 1. The external camera 2 serving as a front camera cannot detect objects present under the floor of the vehicle 1 and objects present entirely below the lower two-dot chain line in side view of the vehicle 1. For this reason, if an object present within the detection range 2R deviates from the detection range 2R of the external camera 2 toward the underneath of the vehicle 1, the object moves downward in the image captured by the external camera 2 and is no longer included in the image, resulting in a lost state.

The vehicle speed sensor 3 is a detector that detects the speed of the vehicle 1. As the vehicle speed sensor 3, for example, a wheel speed sensor that is provided on a wheel of the vehicle 1 or a drive shaft rotating integrally with the wheel and detects the rotation speed of the wheel is used. The vehicle speed sensor 3 transmits the detected vehicle speed information (wheel speed information) to the ECU 10.

The ignition switch 4 is a switch that functions to perform switching between the supply of main power to the ECU 10 and no supply of main power to the ECU 10. The ignition switch 4 has switch states of, for example, an ON state and an OFF state. When the switch state of the ignition switch 4 is the ON state, main power is supplied to the ECU 10. When the switch state of the ignition switch 4 is the OFF state, main power may be intermittently supplied to the external camera 2 and the ECU 10 in order to operate the object recognition apparatus 100. When the switch state of the ignition switch 4 is the OFF state, the ECU 10 may store an inference result, which will be described later, of the object recognition apparatus 100 in a storage unit such as an EEPROM of the ECU 10.

The HMI 5 is an interface for input and output of information between the object recognition apparatus 100 and the occupant (user) of the vehicle 1. The HMI 5 includes, for example, a display and a speaker. The HMI 5 performs image output using the display and/or sound output from the speaker in response to a control signal from the ECU 10. The display may be a multi information display (MID) or a head up display (HUD). The HMI 5 may include an indicator lamp that lights up or flashes when it is inferred that an object is in the hidden state below the vehicle 1, which will be described later.

The communication unit 6 is a communication device that controls wireless communication with the outside of the vehicle 1. For example, the communication unit 6 performs communication of various kinds of information to and from a communication terminal, such as a smartphone held by a user exiting the vehicle 1, through a communication network. The communication unit 6 is not particularly limited, and various known communication devices can be used.

Next, the functional configuration of the ECU 10 will be described. The ECU 10 has an object recognition unit 11, an inference unit 12, and a warning unit 13.

The object recognition unit 11 recognizes an object present within the detection range 2R of the external camera 2 based on the detection result of the external camera 2 that detects objects around the vehicle 1. The object recognition unit 11 recognizes an object present within the detection range 2R of the external camera 2, through known image recognition processing, based on the image captured by the external camera 2. Examples of the object recognized by the object recognition unit 11 may include another vehicle, a pedestrian, a bicycle, and a small animal. The object recognition unit 11 may recognize the relative position, relative speed, and moving direction and the like of an object with respect to the vehicle 1.

When the object recognized by the object recognition unit 11 is recognized to deviate from the detection range 2R of the external camera 2 toward the underneath of the vehicle 1, the inference unit 12 infers that the object is in the hidden state below the vehicle 1. “Infer that the object is in the hidden state below the vehicle” means that there is a risk that the object may be hidden below the vehicle. “There is a risk that the object may be hidden below the vehicle” means that there is a possibility of a lost state in which the object is present in the blind spot of the external camera 2 below the vehicle, such as under the floor of the vehicle or around the vehicle. The blind spot is a range outside the detection range 2R of the external camera 2. In the blind spot, it is difficult for the occupant of the vehicle 1 to visually recognize an object. The object referred to herein is an object that may be entirely hidden within the blind spot of the external camera 2 below the vehicle, and may be, for example, a pedestrian such as a child or a small animal.

“Deviate from the detection range 2R of the external camera 2 toward the underneath of the vehicle 1” may mean “the object deviates from the detection range 2R of the external camera 2 while approaching the vehicle 1” or “the object deviates from the detection range 2R of the external camera 2 while moving away from the vehicle 1”.

As an example, the inference unit 12 calculates a relative distance of an object present within the detection range 2R of the external camera 2 from the vehicle 1 based on an image captured by the external camera 2. When the relative distance of the object decreases within the detection range 2R of the external camera 2 and the object is no longer recognized by the object recognition unit 11 through the lower boundary of the detection range 2R, the inference unit 12 may determine that the object has been recognized to deviate from the detection range 2R of the external camera 2 toward the underneath of the vehicle 1. When the relative distance of the object increases within the detection range 2R of the external camera 2 and the object is no longer recognized by the object recognition unit 11 through the lower boundary of the detection range 2R, the inference unit 12 may determine that the object has been recognized to deviate from the detection range 2R of the external camera 2 toward the underneath of the vehicle 1. For example, when the relative distance of an object does not change within the detection range 2R of the external camera 2, the inference unit 12 may determine that the object has not deviated (the object is recognized not to deviate) from the detection range 2R of the external camera 2 toward the underneath of the vehicle 1. Alternatively, when the object recognition unit 11 continues recognizing an object within the detection range 2R of the external camera 2, the inference unit 12 may determine that the object has not deviated from the detection range 2R of the external camera 2 toward the underneath of the vehicle 1.

FIG. 2 is a drawing for explaining an example of inferring that an object is in the hidden state. In the situation shown in FIG. 2, when the object 20 within the detection range 2R of the external camera 2 mounted on the vehicle 1 approaches the vehicle 1 along the road surface, if the object 20 is no longer present within the detection range 2R, the object 20 moves downward in the image captured by the external camera 2 and is no longer included in the captured image, resulting in a lost state. This state corresponds to the hidden state, that is a state in which there is a risk that the object 20 may be hidden below the vehicle 1. The object 20 may be, for example, a small animal. Thus, with respect to the object 20 approaching the vehicle 1, when the object 20 recognized by the object recognition unit 11 deviates from the detection range 2R of the external camera 2 toward the underneath of the vehicle 1, the inference unit 12 can infer that the object 20 is in the hidden state below the vehicle 1.

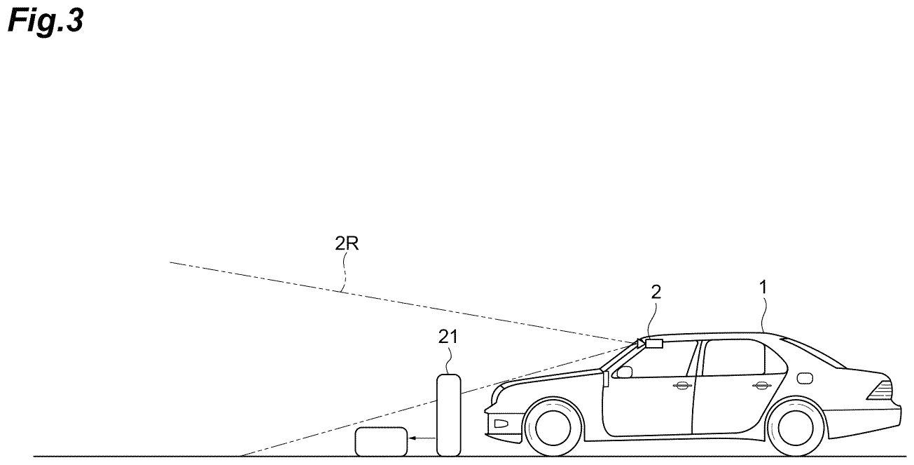

FIG. 3 is a drawing for explaining another example of inferring that an object is in the hidden state. In the situation shown in FIG. 3, when an object 21, a part of which was present within the detection range 2R of the external camera 2 mounted on the vehicle 1, moves away from the vehicle 1 along the road surface, if the part present within the detection range 2R of the external camera 2 is no longer present within the detection range 2R due to a reduction in the height of the object 21, detection by the external camera 2 is lost downward. This state corresponds to the hidden state, that is a state in which there is a risk that the object 21 may be hidden below the vehicle 1. The object 21 may be, for example, a pedestrian such as a child. The reduction in the height of the object 21 may correspond, for example, to the movement of a pedestrian bending over or crouching from a standing position. Thus, even for the object 21 moving away from the vehicle 1, the inference unit 12 can infer that the object 21 is in the hidden state below the vehicle 1 when the object 21 recognized by the object recognition unit 11 deviates from the detection range 2R of the external camera 2 toward the underneath of the vehicle 1.

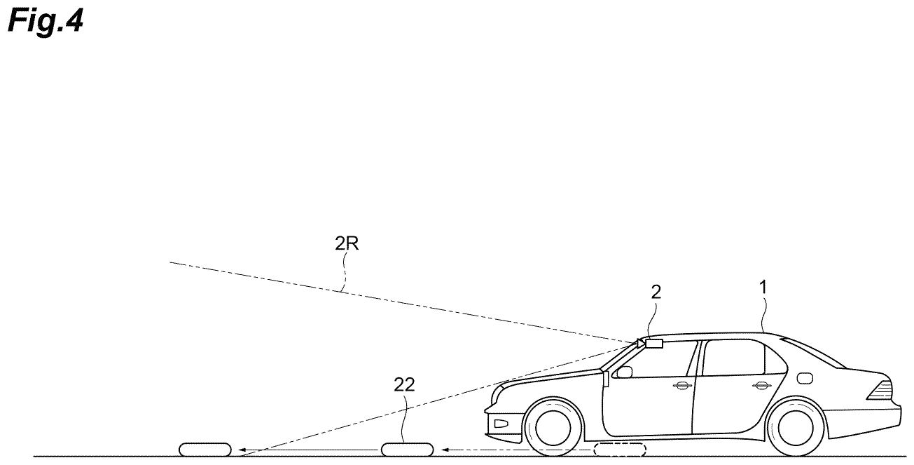

When the object inferred to be in the hidden state is detected again within the detection range 2R of the external camera 2, the inference unit 12 may infer that the object is no longer in the hidden state. FIG. 4 is a drawing for explaining an example of invalidating an inference that an object is in the hidden state. In the situation shown in FIG. 4, when an object 22 present under the floor of the vehicle 1 moves to the front of the vehicle 1 along the road surface, if the object 22 enters the detection range 2R, the object 22 moves from the bottom edge of the image captured by the external camera 2 so as to be included in the captured image. This state corresponds to a state in which the risk that the object 22 may be hidden below the vehicle 1 has been eliminated because the object 22 is detected again by the external camera 2 and is no longer in a lost state. The object 22 may be, for example, a small animal, similar to the object 20. Thus, when the object 22 inferred to be in the hidden state is detected again within the detection range 2R of the external camera 2, the inference unit 12 can infer that the object 22 is no longer in the hidden state.

Here, when inferring that the object is no longer in the hidden state, there is a possibility that fluctuations in object detection by the external camera 2, misdetection of an object by the external camera 2, such as an optical ghost or reflection, and the like will occur. In such a case, for example, the state in which an object is detected again within the detection range 2R of the external camera 2 of the vehicle 1 may continue for only a very short time, and immediately thereafter, the object may deviate from the detection range 2R of the external camera 2. Therefore, when the state in which an object inferred to be in the hidden state is detected again within the detection range 2R of the external camera 2 does not continue for a predetermined no-hiding determination time, the inference unit 12 may not infer that the object is no longer in the hidden state (may continue inferring that the object is in the hidden state).

The no-hiding determination time is a threshold value of the time for determining that it may be inferred that the object is no longer in the hidden state. The no-hiding determination time corresponds to the duration of re-detection of an object that can be considered not to be the misdetection of an object by an external sensor. The no-hiding determination time can be, for example, about 0.5 seconds or 1 second. Alternatively, the no-hiding determination time may be a multiple of the required time by a predetermined coefficient when it is inferred that the object is in the hidden state. The required time can be the time from the time when the external camera 2 starts to detect the object before the object is lost to the time when the object is lost and it is inferred that the object is in the hidden state. The predetermined coefficient may be, for example, a coefficient such as ½ or ⅓. The no-hiding determination time is used, for example, as a threshold value for the elapsed time of a timer from a predetermined measurement start timing. The measurement start timing of the timer may be when the relative distance from the vehicle 1 falls within a predetermined measurement start distance before the object detected again within the detection range 2R of the external camera 2 is lost.

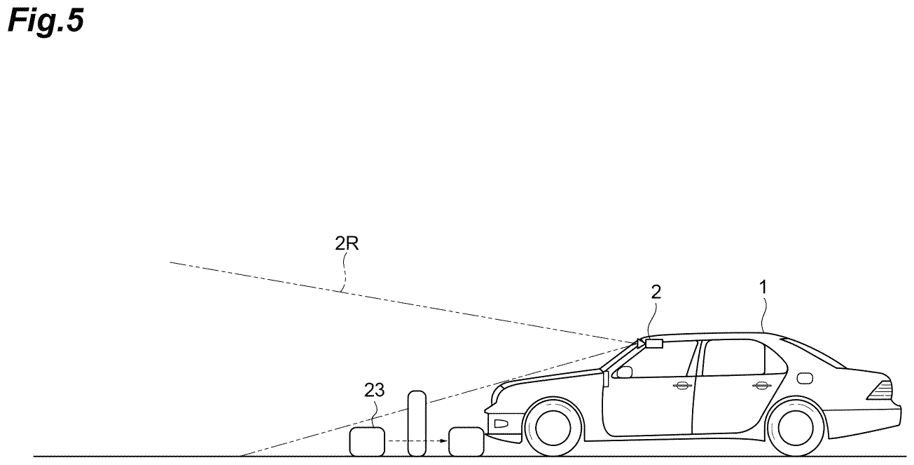

The measurement start distance is the value of the relative distance from the vehicle 1 for starting the timer measurement. The measurement start distance is not particularly limited, but may be a distance corresponding to the lower limit of the detection range 2R of the external camera 2. For example, the measurement start distance may be a distance from the vehicle 1 according to a relative height with respect to the mounting height of the external camera 2, which corresponds to the lower two-dot chain line in FIG. 2 or the like. FIG. 5 is a drawing for explaining an example of continuing to infer that an object is in the hidden state. The situation shown in FIG. 5 is one in which as an object 23 that had deviated from the detection range 2R of the external camera 2 approaches the vehicle 1 along the road surface, the object 23 temporarily becomes partially present within the detection range 2R and immediately thereafter, deviates from the detection range 2R of the external camera 2. Here, the time during which the object 23 is partially present within the detection range 2R is less than the no-hiding determination time. In this case, the temporary re-detection of the object 23 may correspond to a detection fluctuation, such as a case where the object 23 is actually temporarily re-detected due to a change in its height. Thus, when the state in which the object 23 inferred to be in the hidden state is detected again within the detection range 2R of the external camera 2 does not continue for a predetermined no-hiding determination time, the inference unit 12 may not infer that the object 23 is no longer in the hidden state (may continue inferring that the object 23 is in the hidden state). In other words, when the state in which the object 23 inferred to be in the hidden state is detected again within the detection range 2R of the external camera 2 does not continue for a predetermined no-hiding determination time, the inference unit 12 may continue inferring that the object 23 is in the hidden state.

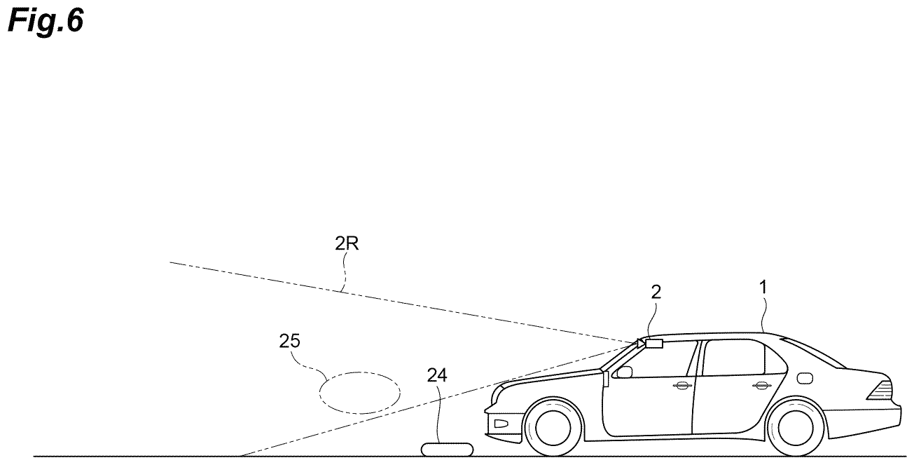

FIG. 6 is a drawing for explaining another example of continuing to infer that an object is in the hidden state. The situation shown in FIG. 6 is one in which while an object 24 that had deviated from the detection range 2R of the external camera 2 has not moved relative to the vehicle 1, a pseudo object 25 is temporarily detected as if the pseudo object 25 is present within the detection range 2R, but immediately thereafter the pseudo object 25 is no longer detected. The pseudo object 25 is not an actual object, but an image of an optical ghost or reflection that is detected as an object within the detection range 2R in a pseudo manner. Here, the time during which the pseudo object 25 is temporarily detected within the detection range 2R is less than the no-hiding determination time. In this case, the object 24 and the pseudo object 25 are not the same object. However, the temporary detection of the pseudo object 25 can be considered similar to the detection fluctuation described above. Therefore, the temporary detection of the pseudo object 25 is treated as being equivalent to the temporary re-detection of the object 24. Thus, when the state in which the pseudo object 25 is detected within the detection range 2R of the external camera 2, instead of the state in which the object 24 inferred to be in the hidden state is detected again within the detection range 2R of the external camera 2, does not continue for a predetermined no-hiding determination time, the inference unit 12 may not infer that the object 24 is no longer in the hidden state. In other words, when the state in which the pseudo object 25 is detected within the detection range 2R of the external camera 2, instead of the state in which the object 24 inferred to be in the hidden state is detected again within the detection range 2R of the external camera 2, does not continue for a predetermined no-hiding determination time, the inference unit 12 may continue inferring that the object 24 is in the hidden state.

When it is inferred that an object is in the hidden state below the vehicle 1, the warning unit 13 may issue a warning about the hiding. The warning unit 13 may alert the occupant (user) of the vehicle 1 through the HMI 5 that there is a risk that an object may be hidden below the vehicle 1.

For example, when the switch state of the ignition switch 4 is the ON state, the warning unit 13 may alert the occupant (user) of the vehicle 1 that there is a risk that an object may be hidden below the vehicle 1, through image output using a display, sound output from a speaker, or lighting or flashing of an indicator lamp.

The warning unit 13 may suspend notification by the HMI 5, for example, when the switch state of the ignition switch 4 is the OFF state. In this case, when the switch state of the ignition switch 4 changes to the ON state, the warning unit 13 may alert the occupant (user) of the vehicle 1 through the HMI 5 that there is a risk that an object may be hidden below the vehicle 1, based on the inference result of object hiding stored in a storage unit such as an EEPROM of the ECU 10.

For example, when the switch state of the ignition switch 4 is the OFF state, the warning unit 13 may alert the occupant (user) of the vehicle 1 that there is a risk that an object may be hidden below the vehicle 1 by communicating various kinds of information to a communication terminal, such as a smartphone held by a user exiting the vehicle 1, through a communication network using the communication unit 6.

### [Processing of Object Recognition Apparatus, Object Recognition Method, and Object Recognition Program]

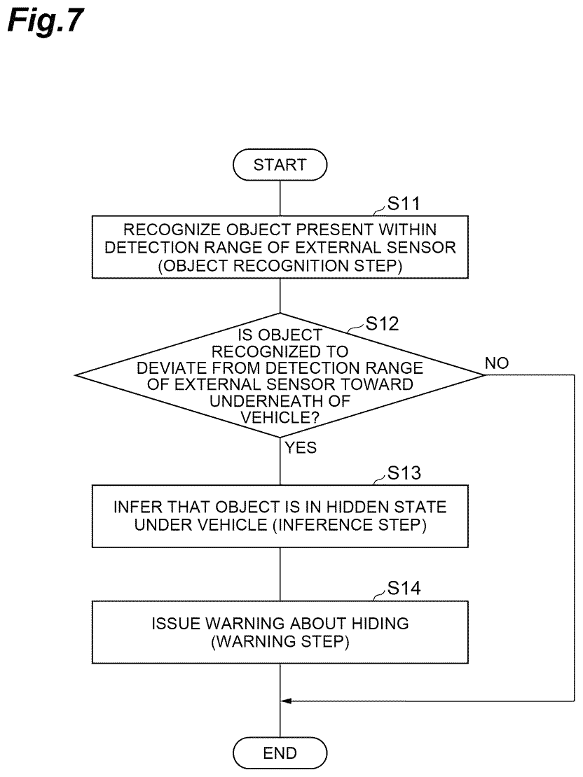

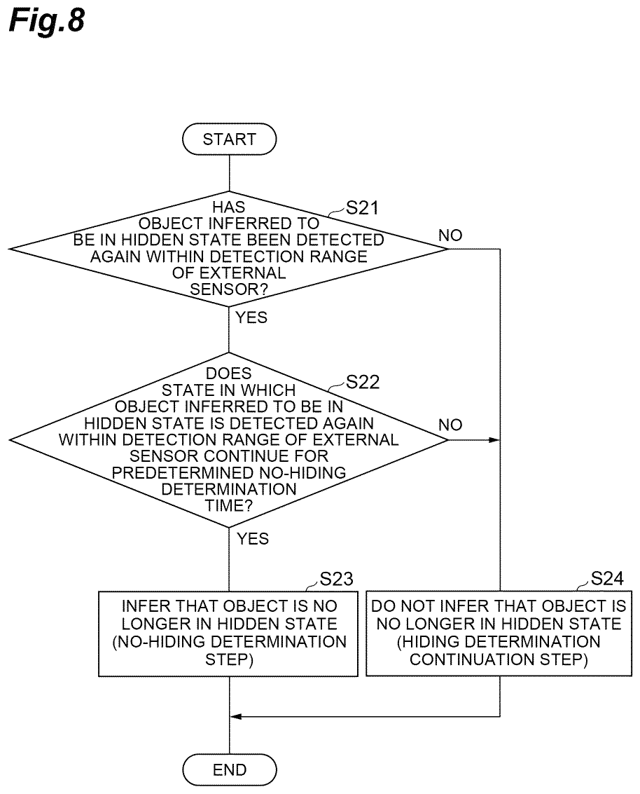

Next, an example of the processing of the object recognition apparatus 100 will be described with reference to the flowcharts of FIGS. 7 and 8. FIG. 7 is a flowchart illustrating an example of a process for inferring that an object is in the hidden state. The process (steps) shown in FIG. 7 is repeatedly executed at predetermined calculation periods, for example, when the vehicle 1 is stopped in a state in which it is not inferred that an object is in the hidden state (for example, a state in which a hide flag is set to 0). The switch state of the ignition switch 4 may be either the ON state or the OFF state.

When the switch state of the ignition switch 4 is the ON state, the process shown in FIG. 7 may be repeatedly executed at predetermined calculation periods when the vehicle speed of the vehicle 1 is less than a vehicle stop determination threshold value based on the detection result of the vehicle speed sensor 3. The vehicle stop determination threshold value is a vehicle speed threshold value for determining that the vehicle 1 is stopped. The vehicle stop determination threshold value is not particularly limited, but may be set to 0.5 km/h, 1 km/h, or 5 km/h.

As shown in FIG. 7, in S11, the object recognition unit 11 of the ECU 10 in the object recognition apparatus 100 recognizes an object present within the detection range of an external sensor (object recognition step). For example, the object recognition unit 11 recognizes the objects 20 and 21 present within the detection range 2R of the external camera 2 based on an image captured by the external camera 2 in FIGS. 2 and 3.

In S12, the inference unit 12 of the ECU 10 determines whether or not the object has deviated (the object is recognized to deviate) from the detection range of the external sensor toward the underneath of the vehicle. As an example, the inference unit 12 calculates the relative distances of the objects 20 and 21 present within the detection range 2R of the external camera 2 from the vehicle 1 based on the image captured by the external camera 2. When the relative distance of the object 20 within the detection range 2R of the external camera 2 decreases and the object 20 is no longer recognized by the object recognition unit 11 through the lower boundary of the detection range 2R, the inference unit 12 may determine that the detected object 20 has deviated from the detection range 2R of the external camera 2 toward the underneath of the vehicle 1. When the relative distance of the object 21 within the detection range 2R of the external camera 2 increases and the object 21 is no longer recognized by the object recognition unit 11 through the lower boundary of the detection range 2R, the inference unit 12 may determine that the detected object 21 has deviated from the detection range 2R of the external camera 2 toward the underneath of the vehicle 1. For example, when the relative distances of the objects 20 and 21 do not change within the detection range 2R of the external camera 2, the inference unit 12 may determine that the recognized objects 20 and 21 have not deviated from the detection range 2R of the external camera 2 toward the underneath of the vehicle 1. When the object recognition unit 11 continues recognizing the objects 20 and 21 within the detection range 2R of the external camera 2, the inference unit 12 may determine that the recognized objects 20 and 21 have not deviated from the detection range 2R of the external camera 2 toward the underneath of the vehicle 1.

When it is determined that the recognized objects 20 and 21 have deviated from the detection range 2R of the external camera 2 toward the underneath of the vehicle 1 (S12: YES), the ECU 10 proceeds to the processing of S13. When it is determined that the recognized objects 20 and 21 have not deviated from the detection range 2R of the external camera 2 toward the underneath of the vehicle 1 (S12: NO), the ECU 10 ends the process of FIG. 7.

In S13, the inference unit 12 of the ECU 10 infers that an object is in the hidden state below the vehicle (inference step). The inference unit 12 infers that there is a risk that the objects 20 and 21 may be hidden below the vehicle 1, and sets the hide flag to 1, for example.

In S14, the warning unit 13 of the ECU 10 issues a warning about the hiding. For example, the warning unit 13 issues a warning about the hiding by outputting a notification sound through the speaker of the HMI 5. The warning unit 13 may issue a warning about the hiding by displaying a notification image on the display of the HMI 5. The warning unit 13 may issue a warning about the hiding by transmitting notification information to a terminal such as a smartphone of the user of the vehicle 1 through the communication unit 6. The processing of S14 may be omitted. Thereafter, the ECU 10 ends the process of FIG. 7.

FIG. 8 is a flowchart illustrating an example of a process for inferring that an object is no longer in the hidden state. The process (steps) shown in FIG. 8 is repeatedly executed at predetermined calculation periods, for example, when the vehicle 1 is stopped in a state in which it is inferred that an object is in the hidden state (for example, a state in which the hide flag is set to 1). The switch state of the ignition switch 4 may be either ON or OFF.

As shown in FIG. 8, in S21, the inference unit 12 of the ECU 10 in the object recognition apparatus 100 determines whether or not an object inferred to be in the hidden state has been detected again within the detection range of the external sensor. For example, in FIG. 4 illustrating a state in which it is inferred that the object 22 is in the hidden state, when the object 22 that has not been present in the detection range 2R and has not been recognized by the object recognition unit 11 is recognized again by the object recognition unit 11 as reappearing in the detection range 2R through the lower boundary of the detection range 2R, the inference unit 12 determines that the object 22 inferred to be in the hidden state has been detected again within the detection range 2R of the external camera 2 based on the image captured by the external camera 2. For example, in FIG. 4 illustrating a state in which it is inferred that the object 22 is in the hidden state, when the object 22 that has not been present in the detection range 2R and has not been recognized by the object recognition unit 11 remains unrecognized, the inference unit 12 determines that the object 22 inferred to be in the hidden state has not been detected again within the detection range 2R of the external camera 2 based on the image captured by the external camera 2.

When it is determined that the object 22 inferred to be in the hidden state has been detected again within the detection range 2R of the external camera 2 (S21: YES), the ECU 10 proceeds to the processing of S22. When it is determined that the object 22 inferred to be in the hidden state has not been detected again within the detection range 2R of the external camera 2 (S21: NO), the ECU 10 proceeds to the processing of S24.

In S22, the inference unit 12 of the ECU 10 determines whether or not the state in which the object inferred to be in the hidden state is detected again within the detection range of the external sensor (re-detection state) continues for a predetermined no-hiding determination time. For example, in FIG. 4 illustrating a state in which it is inferred that the object 22 is in the hidden state, when the object 22 detected again in the detection range 2R is detected continuously for a predetermined no-hiding determination time, the inference unit 12 determines that the re-detection state has continued for the predetermined no-hiding determination time based on the image captured by the external camera 2. For example, in FIG. 4 illustrating a state in which it is inferred that the object 22 is in the hidden state, when the object 22 detected again in the detection range 2R is not detected continuously for the predetermined no-hiding determination time, the inference unit 12 determines that the re-detection state has not continued for the predetermined no-hiding determination time based on the image captured by the external camera 2.

When it is determined that the re-detection state has continued for the predetermined no-hiding determination time (S22: YES), the ECU 10 proceeds to the processing of S23. When it is determined that the re-detection state has not continued for the predetermined no-hiding determination time (S22: NO), the ECU 10 proceeds to the processing of S24.

In S23, the inference unit 12 of the ECU 10 infers that the object is no longer in the hidden state below the vehicle (no-hiding determination step). The inference unit 12 infers that the risk of the object 22 being hidden below the vehicle 1 has been eliminated, and sets the hide flag to 0, for example. Thereafter, the ECU 10 ends the process of FIG. 8.

In S24, the inference unit 12 of the ECU 10 does not infer that the object is no longer in the hidden state below the vehicle (hiding determination continuation step). The inference unit 12 infers that the risk of the object 22 being hidden below the vehicle 1 has not been eliminated (continues inferring that the object 22 is in the hidden state). The inference unit 12 infers that there is still a risk that the object 22 may be hidden below the vehicle 1, and maintains the hide flag at 1, for example. In S24, the warning unit 13 of the ECU 10 may continue issuing a warning about the hiding. Thereafter, the ECU 10 ends the process of FIG. 8.

### [Object Recognition Program]

An object recognition program causes the ECU 10 (computer) to function (operate) as the object recognition unit 11, the inference unit 12, and the warning unit 13 described above. The object recognition program is provided by a non-transitory recording medium, such as a ROM or a semiconductor memory. In addition, the object recognition program may be provided through communication using a network or the like.

According to the object recognition apparatus 100, the object recognition method, and the object recognition program described above, when the objects 20 and 21 recognized within the detection range 2R of the external camera 2 deviates from the detection range 2R toward the underneath of the vehicle 1, it is inferred that the objects 20 and 21 are in the hidden state below the vehicle 1. Therefore, it is possible to infer that there is a risk that the objects 20 and 21 may be hidden below the vehicle 1 by using the external camera 2 that detects the objects 20 and 21 around the vehicle 1.

In the object recognition apparatus 100, the object recognition method, and the object recognition program, when the object 22 inferred to be in the hidden state is detected again within the detection range 2R of the external camera 2, it is inferred that the object 22 is no longer in the hidden state. Therefore, it is possible to infer that the risk of the object 22 being hidden below the vehicle 1 has been eliminated by using the external camera 2 that detects the object 22 around the vehicle 1.

In the object recognition apparatus 100, the object recognition method, and the object recognition program, when the state in which the object 23 inferred to be in the hidden state is detected again within the detection range 2R of the external camera 2 does not continue for a predetermined no-hiding determination time, it is not inferred that the object 23 is no longer in the hidden state. Therefore, since the influence of, for example, erroneous detection by the external camera 2 is reduced, it is possible to more accurately infer that there is a risk that the object 23 may be hidden below the vehicle 1.

While the examples of the present disclosure has been described above, the present disclosure is not limited to the above examples.

In the above examples, the external camera 2 is exemplified as an external sensor, but the external sensor is not limited to this example. A radar sensor may be used as an external sensor. The radar sensor is an external sensor for detecting an object outside the vehicle 1. Examples of the radar sensor include a millimeter wave radar and a LiDAR (light detection and ranging). The radar sensor detects an object around the vehicle 1 by using radio waves (for example, millimeter waves) or light, and detects the distance between the vehicle 1 and the object. That is, the radar sensor also functions as a distance measurement sensor that measures the distance between the vehicle 1 and an external object. The external sensor may be a sonar sensor. The object recognition unit 11 may recognize an object present within the detection range of the external sensor based on the detection result of the external sensor. The detection range of the external sensor may be a range that does not include the space below the vehicle 1. The detection range of the external sensor may include a part of the space below the vehicle 1.

As an external sensor, the external camera 2 and a radar sensor may be used in combination. When a plurality of sensors or cameras are used as external sensors, when the switch state of the ignition switch 4 is the OFF state, some of the external sensors or cameras may not be used to reduce power consumption.

In the above examples, when the state in which an object inferred to be in the hidden state is detected again within the detection range 2R of the external camera 2 does not continue for a predetermined no-hiding determination time, the inference unit 12 does not infer that the object is no longer in the hidden state (continues inferring that the object is in the hidden state). However, the present disclosure is not limited to this example. For example, whether to infer that the object is no longer in the hidden state or to continue inferring that the object is in the hidden state may be determined based on the result of averaging or filtering the state of whether or not the object inferred to be in the hidden state has been detected again within the detection range 2R of the external camera 2 for a predetermined time.

In the above examples, the inference unit 12 infers that the object is no longer in the hidden state when the object inferred to be in the hidden state is detected again within the detection range 2R of the external camera 2, but the present disclosure is not limited to this example. For example, the inference that the object is in the hidden state may be invalidated by inputting to the HMI 5 a result of visually checking the area outside the detection range 2R of the external camera 2 by the user of the vehicle 1. In addition, the inference unit 12 may be configured to infer that the object is in the hidden state even when the vehicle 1 is traveling.

In the above examples, the object recognition apparatus 100 includes the warning unit 13, but the warning unit 13 may be omitted. The result of inferring that an object is in the hidden state by the object recognition apparatus 100 may be used for other controls for purposes other than warning the user.

When the vehicle 1 includes an autonomous driving ECU capable of performing autonomous driving control, the result of inferring that an object is in the hidden state may be used for the autonomous driving control. When it is inferred that an object is in the hidden state while the vehicle 1 is in autonomous driving, the object recognition apparatus 100 may cause the autonomous driving ECU to perform autonomous driving control of the vehicle 1 so that the tires of the vehicle 1 do not run over the hidden object.

For example, when it is inferred that an object recognized by the object recognition apparatus 100 as being present near the center of the vehicle 1 in its width direction is in the hidden state while the vehicle 1 is traveling straight ahead, the autonomous driving ECU may control the steering angle of the vehicle 1 so that the tires of the vehicle 1 do not run over the object hidden below the vehicle 1. In this case, when it is inferred, based on the relative speed of the recognized object in the vehicle width direction, that the hidden object is present near the center of the vehicle 1 in its width direction below the vehicle 1, the possibility of the rear tires running over the object hidden below the vehicle 1 may be reduced by suppressing or prohibiting changes in the steering angle of the vehicle 1 while traveling straight ahead. When it is inferred, based on the relative speed of the recognized object in the vehicle width direction, that the hidden object is present near both ends of the vehicle 1 in its width direction below the vehicle 1, the possibility of the rear tires running over the object hidden below the vehicle 1 may be reduced by changing the steering angle of the vehicle 1 so that the trajectories of the rear tires do not overlap the location of the object inferred to be in the hidden state.

In addition, when it is inferred that an object recognized by the object recognition apparatus 100 as being present near one of both ends of the vehicle 1 in its width direction is in the hidden state while the vehicle 1 is traveling straight ahead at a slow speed, the autonomous driving ECU may operate the brakes of the vehicle 1 so that the tires of the vehicle 1 do not run over the object hidden below the vehicle 1.

In addition, when the vehicle 1 includes a driving assistance ECU capable of performing driving assistance control instead of the autonomous driving ECU capable of performing autonomous driving control, the result of inferring that an object is in the hidden state may be used for the driving assistance control. When it is inferred that an object is in the hidden state while the vehicle 1 is being manually driven, the object recognition apparatus 100 may cause the driving assistance ECU to perform driving assistance control, such as the above-described control of the steering angle or brakes, so that the tires of the vehicle 1 do not run over the hidden object.

What is claimed is:

1. An object recognition apparatus, comprising:
an object recognition unit configured to recognize an object around a vehicle, which is present within a detection range of an external sensor for detecting the object, based on a detection result of the external sensor; and
an inference unit configured to infer that the object is in a hidden state below the vehicle when the object is recognized to deviate from the detection range of the external sensor toward underneath of the vehicle.

2. The object recognition apparatus according to claim 1,
wherein, when the object inferred to be in the hidden state is detected again within the detection range of the external sensor, the inference unit infers that the object is no longer in the hidden state.

3. The object recognition apparatus according to claim 2,
wherein, when a state in which the object inferred to be in the hidden state is detected again within the detection range of the external sensor does not continue for a predetermined no-hiding determination time, the inference unit does not infer that the object is no longer in the hidden state.

4. An object recognition method of an object recognition apparatus for recognizing an object around a vehicle, comprising:
recognizing whether or not the object is present within a detection range of an external sensor for detecting the object, based on a detection result of the external sensor, by the object recognition apparatus; and
inferring that the object is in a hidden state below the vehicle by the object recognition apparatus when the object is recognized to deviate from the detection range of the external sensor toward underneath of the vehicle.

5. An object recognition program causing a computer to function as an object recognition apparatus for recognizing an object around a vehicle based on a detection result of an external sensor for detecting the object, the object recognition program causing the computer to function as:
an object recognition unit configured to recognize whether or not the object is present within a detection range of the external sensor based on the detection result of the external sensor; and
an inference unit configured to infer that the object is in a hidden state below the vehicle when the object is recognized to deviate from the detection range of the external sensor toward underneath of the vehicle.
